(19) United States
(12) Patent Application Publication
(10) Pub. No.: US 2013/0019503 A1
(43) Pub. Date: Jan. 24, 2013

(54) METHOD AND APPARATUS FOR COOLING FOOTWEAR

(71) Applicant: Brian James Vogt, Harrisburg, PA (US)

(72) Inventor: Brian James Vogt, Harrisburg, PA (US)

(21) Appl. No.: 13/475,180

(22) Filed: May 18, 2012

Related U.S. Application Data
(60) Provisional application No. 61/488,161, filed on May 20, 2011.
(60) Provisional application No. 61/623,849, filed on Apr. 13, 2012.

(51) Int. Cl. A43B 7/06; F25B 21/02; H02J 7/00; A43B 13/14

(52) U.S. Cl. 36/103; 36/3 B; 62/3.2; 320/108

(57) ABSTRACT

The invention provides methods and apparatus for cooling (or heating) feet by use of air movers and/or thermoelectric heat exchangers within footwear. The invention employs heat exchangers with no moving parts and a flat form factor, such as Peltier heat exchangers, directly within the sole and/or heel of the footwear. Alternately or additionally, the inventive footwear may employ air movers with no moving parts and a flat, flexible form factor, such as ionic air movers, disposed directly within the sole and/or heel in fluid communication with the interior of the footwear. The sole and/or heel of the footwear may include air channels in communication with the environment outside of the shoe via air inlet and/or outlet openings in the heel and/or sole. The invention may further include electronics and wireless technology for monitoring the climate within the footwear and issue alerts to the wearer or others.

### RELATED APPLICATIONS

This application claims priority to U.S. provisional patent application Nos. 61/488,161 filed May 20, 2011 and 61/823,849 filed Apr. 13, 2012, which are incorporated herein by reference in their entireties.

### FIELD OF THE INVENTION

The invention pertains to methods and apparatus for monitoring and actively controlling the climate of a foot through footwear.

### BACKGROUND OF THE INVENTION

There is a need for footwear, such as shoes, boots, and sneakers, with improved climate control, including temperature and/or moisture control, through the use of heat exchange and/or ventilation in order to enhance the comfort and health of the wearer's feet. This is particularly important for diabetics and other persons with poor blood circulation to their feet and/or sensory neuropathy in their feet. Such persons may, and often do, suffer serious medical problems, including ulcers and the possible need for amputation, if their feet remain too hot or moist for extended periods of time, and, due to sensory neuropathy, such persons may not even be able to detect that their feet are hot or wet. Also, a hot spot on the feet, i.e., when one part of the foot is at a markedly higher temperature than other parts of the foot or the corresponding part of the other foot, is a pre-indicator of an ulcer.

### SUMMARY OF THE INVENTION

The invention provides methods and apparatus for actively cooling (or heating) feet through the use of thermoelectric heat exchangers and/or active ventilators or air movers embedded within footwear, such as shoes, boots, sneakers, and socks. The inventive footwear may employ heat exchange technology with no moving parts and a flat, flexible form factor, such as Peltier heat exchangers, fitted directly within the sole and/or heel of the footwear. Alternately or additionally, the inventive footwear may employ air movers with no moving parts and a flat, flexible form factor also fitted directly within the sole and/or heel of the footwear, such as ionic or coronal discharge air movers, in fluid communication with the interior of the footwear. The sole and/or heel of the footwear may include air channels in communication with the outside environment via air inlet and/or outlet openings in the surface of the heel and/or sole.

According to further aspects of the invention, electronics and wireless technology may be utilized to monitor the active climate control devices and/or actual climate within the footwear and issue alerts to the wearer or others as to any conditions that may require attention or intervention.

### BRIEF DESCRIPTION OF THE DRAWINGS

FIG. 1A is a see-through side elevation view of a shoe in accordance with a first exemplary embodiment of the present invention.

FIG. 1B is a see-through bottom plan view of the shoe of FIG. 1A.

FIG. 2A is a top plan view of an exemplary ionic air mover that may be used in the present invention.

FIG. 2B is a side view of the ionic air mover of FIG. 2A.

FIG. 3 is a block diagram illustrating the various electrical components of an exemplary shoe in accordance with an embodiment of the invention.

FIG. 4A is a sectional side elevation view of a shoe in accordance with a second exemplary embodiment of the present invention.

FIG. 4B is a see-through bottom plan view of the shoe of FIG. 4A.

FIG. 5A is a sectional side elevation view of the heel portion of a shoe in accordance with a third exemplary embodiment of the present invention.

FIG. 5B is a see-through bottom plan view of the heel portion of the shoe of FIG. 5A.

### DETAILED DESCRIPTION

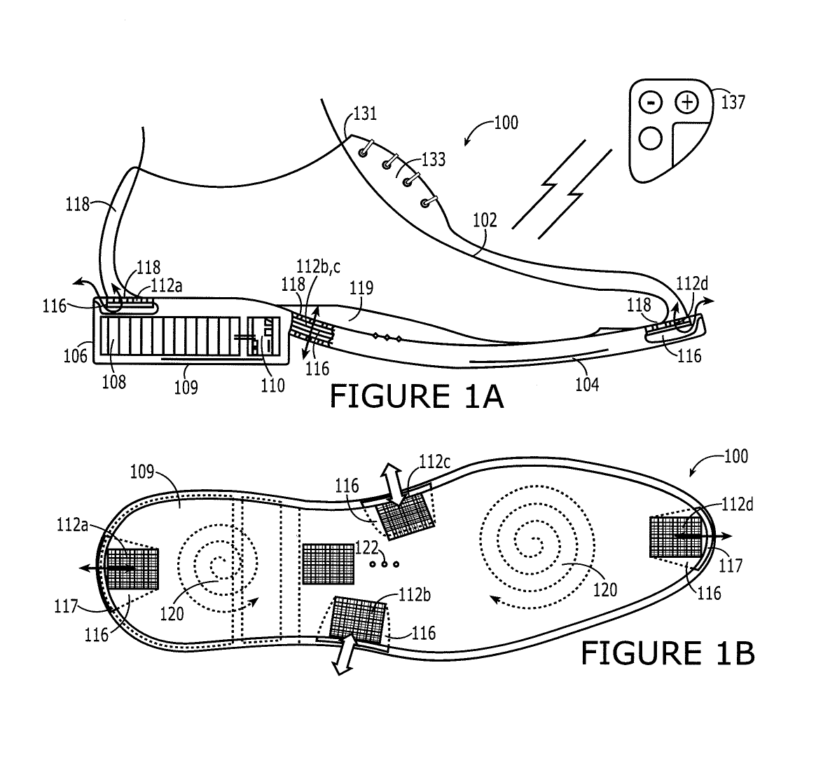

FIGS. 1A and 1B illustrate a shoe 100 incorporating at least some of the principles and aspects of the present invention in accordance with a first embodiment thereof. FIG. 1A is a side view of the shoe with the heel 109, sole 104, and upper 102 of the shoe shown transparently so that the various electrical components, air channels, and the like within the shoe can be observed. FIG. 1B is a bottom view of the shoe 100 with the sole 104 and heel 109 (collectively, “bottom”) similarly shown transparently so as to allow observation of the various components inside the shoe. In accordance with this embodiment of the invention, one or more ionic air movers 112a, 112b, 112c, 112d are disposed in the sole 104 of the shoe 100. This particular embodiment has four such air movers, comprising one in the heel 112a, one near the toe 112d, and two 112b, 112c near the middle of the shoe. Ionic air movers, such as air movers 112a-112d, are electrically operated devices capable of creating an air current without moving parts.

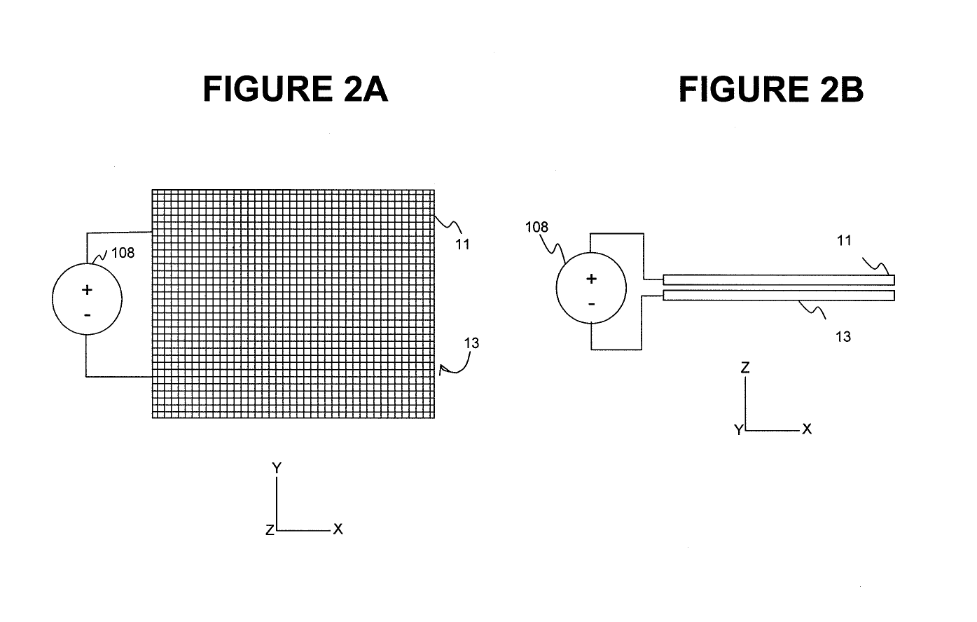

Ionic air movers are known in the art and will not be described in great detail herein. However, FIGS. 2A and 2B are plan and elevation views, respectively, of the basic components of one exemplary mesh ionic air mover 112. It comprises two parallel, conductive meshes 11, 13 that are oppositely charged via a DC electrical voltage source, such as a battery 108. At least one of the mesh sheets, e.g., sheet 11, is used to generate ions by means of coronal discharge. Corona discharge occurs when a high voltage is passed through a conductor having an appropriate shape to ensure a high potential gradient in the air surrounding the conductor, but not enough of a potential gradient to cause arcing through the air. These ions are basically O₃ particles (i.e., ozone) and have a net charge. Because they have a net charge, they will be repelled from the mesh layer having the same polarity as the ions, e.g., mesh layer 13, while simultaneously being attracted to the other mesh layer (or electrode), e.g., 11, having the opposite polarity as the ions.

Even after the coronal discharge process, only a small percentage of the molecules between the two electrodes 11, 13 are ionized. Nevertheless, the ionized particles that are accelerated by the electrodes push many additional neutral air molecules along with them, thereby creating an air current.

This type of air moving device has no moving parts and sometimes called an electrostatic fluid accelerator, an ionic air mover, or a coronal discharge air mover. These types of air movers can be made very small and are used for many applications, including cooling of microchips and computer processors. The two mesh layer type ionic air mover can be designed to move air in the Z direction, i.e., the direction perpendicular to the planes of the electrode meshes 11, 13, as described above. However, they also can be designed to move air in the X and/or Y direction parallel to the planes of the mesh layers 11, 13.

Referring back to FIGS. 1A and 1B, the ionic air movers 112a-112d are disposed in the sole 104 and/or heel 109 of the shoe 100 within air channels 116 that are in fluid communication with the outside environment through one or more air inlet and/or outlet ports 117 in the bottom or side of the sole or heel. The ionic air movers 112a-112d are powered by an on-board battery, such as battery 108 disposed in the heel 109 of the shoe 100. In addition, electronic circuitry 110, which also receives power from the battery 108, is disposed somewhere in the shoe, such as in the heel 109 or the sole 104, and controls the ionic air mover 112 according to its programming or design. In a preferred embodiment, the air mover(s) 112a-112d are adhered, sewn, screwed, or otherwise attached to the sole 104 at portions 118 of the sole that are air permeable. The remainder of the sole 104 that is not adjacent to the air movers may be solid or may also be air permeable.

In one preferred embodiment, at least some of the ionic air movers 112a-112d are operated to push air upwardly through the air permeable portions (or vents) 118 of the sole 104 into the interior of the shoe to ventilate and cool the wearer's foot. Accordingly, the ports 117 in the sole and heel of the shoe corresponding to those air movers may be considered air inlet ports and the air permeable portions 118 above the air movers 112 air outlet ports relative to the air mover. The air that enters the shoe in this manner may be expelled from the various openings in the upper 102 of the shoe 100, such as the foot hole 131 and tongue 133. Generally, there usually is sufficient empty space, such as spaces 118 and 119, within a shoe between the wearer's foot and the inner surfaces of the upper 102 and/or sole 109 for such air flow to occur.

In one preferred embodiment, some of the air movers are operated to push air into the interior of the shoe and others are operated to pull air out of the interior of the shoe. Thus, for instance, two of the air movers 112 may be designed to push air upwardly into the shoe interior and the other two air movers 112 may be designed to push air downwardly to pull air from the shoe interior so as to provide an air circulation loop through the interior of the shoe.

The forced air flow through the shoe will not only cool the wearer's foot, but will also carry moisture out of the shoe, leading to a cooler, drier, and overall more comfortable and healthier wearing experience for the wearer.

In some embodiments, the sole may be solid over its entire surface such that the air movers simply move air through the sole of the shoe, which cools the sole of the shoe, which, in turn, cools the wearer's foot convectively through the solid sole.

One or more sensors 122 may be disposed in the shoe, such as inside the shoe on the upper surface of the sole 104, to monitor temperature, moisture, or other conditions in the shoe. The electronic circuitry 110, for instance, may be designed to read data from the sensors 122 and turn on the ionic air movers 112 when one or more of the sensors 122 detects temperature in excess of some predetermined value or moisture in excess of some predetermined value.

In addition, the ozone created by the ionic air movers is known to have positive health and well being effects to humans. Thus, the discharge of air upwardly out of the upper through the foot hole and tongue and/or the incorporation of air discharge outlets facing upwardly on the sole (as shown for heel air mover 112a) in the upper of the shoe to cause the ions to be discharged from the shoe upwardly toward the wearer may have added health benefits to the wearer.

The ionic air movers are small, low power, noiseless, safe, robust, and have no moving parts. In addition, they have a flat form factor and are flexible, making them ideal for incorporation into the soles of shoes. Also, the air movement and ventilation has the added benefit of deodorization.

The air flow channels 116 inlet/outlet ports 117 on the surface of the shoe and permeable portion 118 of the sole 104 should be designed to allow optimal, low impedance air flow through the air channels and to provide maximum air flow around the sole of the foot. For instance, it is best not to place the vents 118 directly under the centers of the heel and ball of the foot because those portions of the foot are commonly in firm contact with the sole of the shoe and might block the vents 118. It is more preferable to position those vents 118 near the back of the shoe behind the heel, under the arch of the foot, and/or in front of or around the toes of the foot.

In a preferred embodiment, the air movers are removable and replaceable in case they fail or need to be cleaned or otherwise serviced.

In one embodiment, two air movers may be disposed in the shoe, one behind the heel and one near the toe, with one of the air movers adapted to push air upwardly into the inside of the shoe and the other adapted to pull air downwardly out of the shoe, thereby setting up an air circulation pattern through the entire interior of the shoe. In other embodiments, there may be a multiplicity of air movers and associated inlets and/or outlets distributed along the sole. In some preferred embodiments, the air mover(s) and air channel(s) are positioned under the heel and ball of the foot to provide maximum air flow for cooling and moisture near the heel and the ball because, when standing, the hottest and most moist parts of the foot typically are the heel and ball.

Generally, air flow will be improved when the wearer is walking, due to the extra movement of air around the shoe because the shoe is moving through the outside air, thereby increasing air flow through the air flow channels 116 and inlet and outlet ports 117. In addition, air flow will likely be improved as compared to standing when the wearer is sitting because the sole and heel of the shoe typically will be less compressed when the wearer is sitting.

The inlet and outlet ports 117 may be permanently open to the outside environment. However, this may limit the utility or at least comfort of the shoe when it is raining or snowing due to the possibility of water ingress into the interior of the shoe through the ports 117 and the air channels 116 and through the air permeable portions 118 of the sole adjacent the air movers 112. Accordingly, in some embodiments, the inlet and outlet ports 117 may be provided with slidable or otherwise moveable covers so that the user may close off the ports 117 in inclement weather. In yet other embodiments, the inlets and outlets may be covered with a selective moisture barrier, such as Gortex™ or Nikwax™.

In yet other embodiments, the moveable covers may be automatically controlled via the on-board electronics 110 and electro-mechanical means for opening and closing them. For instance, in one embodiment, one or more of the sensors 122 may be a moisture sensor on the outside of the shoe and the electronics 110 may be designed to close the ports 117 when the moisture sensor senses a moisture level above a predetermined threshold, indicative of the likelihood of rain, snow or other inclement weather.

The flat shape, small form factor, and flexibility of ionic air movers makes them ideally suited for incorporation into the soles of shoes. Particularly, an ionic air mover may be shaped and sized to lay flat against the majority of the upper wall of the sole of the shoe and thereby provide uniform distributed air flow over substantially the entire surface of the sole (and thus the bottom of the foot).

Suitable ionic air movers for the aforedescribed applications include the Ventiva ICE™ available from Ventiva, Inc.

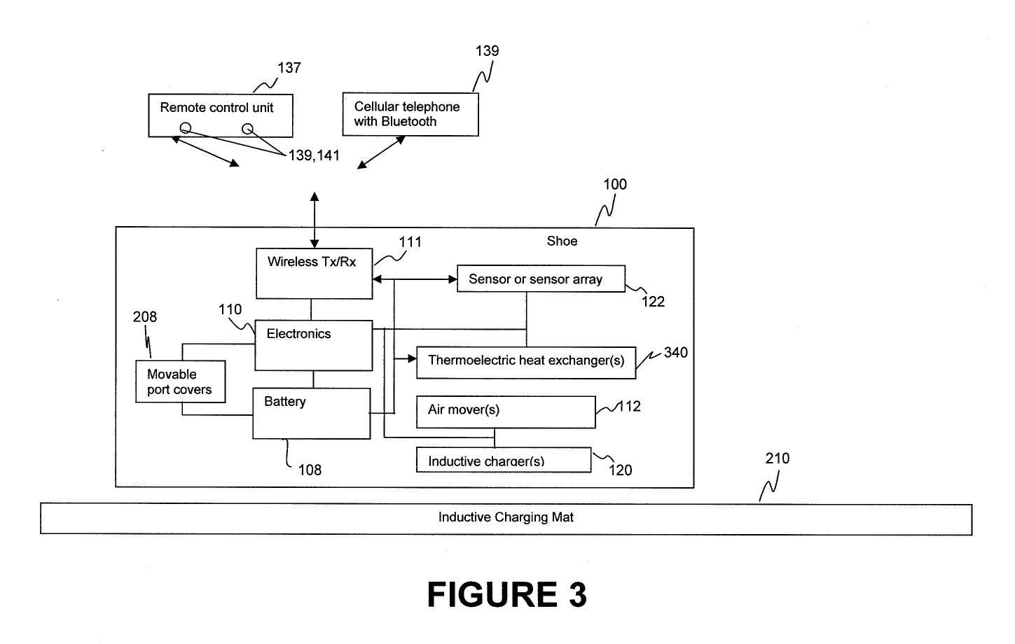

FIG. 3 is a block diagram illustrating the electrical interconnection of the various components of a shoe discussed hereinabove in accordance with the present invention. In one embodiment, the wearer is provided with a remote control unit that can be used to control various functions of the electrical components of the shoe, such as control over the operation of the air movers 112 and/or mechanized port coverings 208. Particularly, the shoe may further incorporate a wireless transmitter/receiver 111, such as a Bluetooth transceiver that can communicate with a remote control unit 137 that the wearer can carry with him or her. The remote control unit 137 may be as simple as comprising a first on/off switch or button 138 for turning the ionic air mover on and off and a second switch or button 141 for opening and closing the air inlet/outlet ports 117 of the air channels. In more robust embodiments, the wearer may be permitted, through use of the remote control unit, to set the temperature or moisture levels at which the air mover(s) will be turned on or off and/or at which the ports 117 will open and close.

The remote control unit 137 may be adapted to be carried in one's pocket, clipped to one's belt, or held in one's hand, much like a cellular telephone. Although not preferred, in other embodiments, there may be no remote control unit or other wireless interface, but the shoe may contain one or more switches or buttons for allowing user control.

As an additional feature, a pedometer may be included in the shoe so that step count can be communicated wirelessly to the user via the wireless link.

In yet other embodiments, instead of a purpose-built remote control unit 137, the wearer may load a software application on his or her cellular telephone 139 that provides any functionality that might otherwise be provided through the remote control unit 137. The telephone 139 can communicate with the electronics in the shoe using its Bluetooth transceiver just as discussed above in connection with the remote control unit 137.

While the invention has thus far been described in connection with a shoe, it may be incorporated into other forms of footwear, such as boots, sneakers, or even socks. In fact, the same technology can also be incorporated into other garments, such as underwear to provide similar benefits in connection with other parts of the body. In a sock embodiment, the ionic air mover(s) 112 and electronic circuitry 110 may be embodied directly in the sock, such as by stitching them between two layers of fabric or otherwise embedding them directly within the fabric of the sock. Current ionic air mover and microchip technologies are quite robust such that they can withstand the bending and wear when disposed on the bottom of a sock. The battery 108 may be too bulky to dispose on the bottom of a sock and may need to be disposed on the upper portion of the sock or worn around the leg of the user with a strap. On the other hand, modern gel battery technology may permit a practical embodiment in which the battery also is embodied in the sock in a distributed manner over the bottom of the sock or other parts of the sock.

In a sock embodiment, it generally will not be necessary to provide purpose-built air channels for the air flow inasmuch as most conventional sock materials themselves are substantially air permeable such that the fabric itself requires no additional ventilation channels.

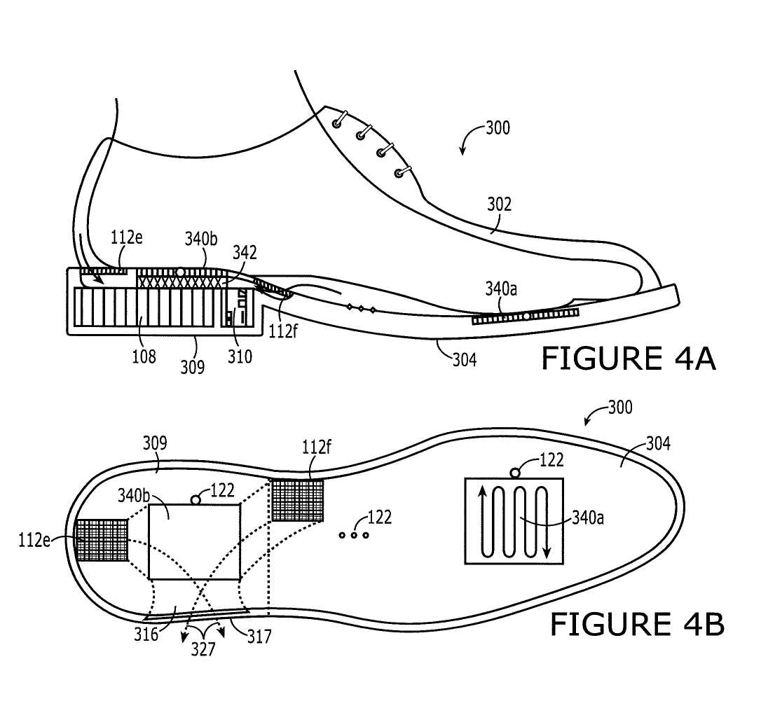

FIGS. 4A and 4B illustrate an alternative embodiment of the invention in which one or more thermoelectric cooling units 340a, 340b are disposed in the sole 304 of a shoe 300. Particularly, there are two such heat exchangers 340a and 340b in the illustrated embodiment, a first one 340a under the ball of the foot and a second one 340b under the heel of the foot. The heat exchanger 340a in the front of the shoe 300 cools the ball of the foot convectively through direct contact with the sole 304 under the ball of the foot, which also is in direct contact with the sole 304 on the opposite (upper) side of the sole 304, as will be discussed in more detail below. It may be preferable to form the sole of a material with a high thermal coefficient or to incorporate vents adjacent the heat exchangers to improve corrective coolers or conductive coolers, respectively.

Thermoelectric heat exchangers utilize the Peltier Effect and are sometimes called Peltier Effect heat exchangers. Thermoelectric heat exchangers are well known in the art and will not be described in detail herein. However, briefly, a Peltier Effect heat exchanger is a solid state active heat pump that transfers heat from one side of the device to the other when direct current is run through it.

Particularly, it creates a heat flux between the junction of two different types of materials. Therefore, it may be used to heat or to cool depending on its orientation and/or the direction of the direct current through it. A thermoelectric heat exchanger generally comes in the form factor of a flat, thin ceramic, such as the Laird 430 Thermo-Electric Module (TEM) available from Laird Technologies. They are also available as a flexible sheet such as Perpetua's TEFilm available from Perpetua Power Source Technologies, Inc. of Corvallis, Oreg., USA and, therefore, are well suited to incorporation into the sole of a shoe.

The thermoelectric heat exchanger 340b in the rear of the shoe illustrates another feature. Particularly, embodiments may incorporate both thermoelectric heat exchangers and air movers, working together to more effectively cool the foot. Particularly, the movement of the air caused by the air mover is use to help increase the efficiency of the heat exchanger by moving air over the hot surface of the heat exchanger (and/or any heat sinks), thereby increasing their capacity to transport heat away from the foot.

For instance, in the embodiment illustrated in FIGS. 4A and 4B, the rear of the shoe 300 further incorporates two ionic air movers 112e and 112f such as those described in connection with the embodiment of FIGS. 1A and 1B. They are disposed in an air channel 316 in which the heat exchanger 340b also is disposed. These air movers 112e and 112f may operate largely as described above in connection with the embodiment of FIGS. 1A and 1B to move air through the interior of the shoe though vents 118 in the sole 304. However, they further operate to move air through the air channel 316 to cool the heat exchanger and/or a heat sink 342 attached to the hot, bottom side of the heat exchanger 340b. In the illustrated embodiment, both air movers 112e and 112f are operated to pull air downwardly so as to draw air from the interior of the shoe and direct it through air channel 316 over and/or through the heat exchanger 340b and heat sink 342 and out of air port 317 as illustrated by arrows 327.

Of course, a heat sink also may be attached to the front heat exchanger 340a to improve its efficiency in removing heat from the foot. Alternately, the sole and/or heel of the shoe may incorporate (or be made entirely of) a material such as a carbon-loaded rubberized polymer, for instance, nylon and silicone, with a high thermal coefficient so that the sole 304 and/or heel 309 themselves act as an efficient heat sinks.

Heat conducts from the foot at the points of contact through the thermoelectric cooling unit(s) 340a, 340b and into the heat sink(s) 342, if any, and, from there through the surfaces of the sole 304 and heel 309 to the outside environment.

As in the previously described embodiment, a battery 108, electronic circuitry 110, and sensors 122 may be incorporated into the design. Note the additional sensors 122 disposed near the thermoelectric heat exchangers. These may be useful in monitoring the temperature of the heat exchangers 340, 340b themselves, rather than or in addition to the temperature of the foot (for instance, when the heat exchangers are turned off). Specifically, it may be desirable to monitor for excess cold on the heat exchanger, which could harm the foot or cause condensation in the shoe. This could happen, for instance, if contact is lost between the foot and sole, such as when sitting with a foot crossed and elevated. Alternately, it may be desirable to monitor for excessive heat buildup on the hot side of the heat exchangers that might be harmful to the shoe, the heat exchanger itself, and/or the wearer. For instance, the electronics 110 may read these sensors 122 and turn off the heat exchangers 340a, 340b if they detect temperatures under or over a predetermined threshold.

Also note that the sole may be solid over its entire surface so that the air movers 112a, 112b are used substantially only to move air over the heat exchangers 340a, 340b and/or the heat sink 342 and not to ventilate the interior of the upper 302 of the shoe.

Normally, the cool side of the thermoelectric heat exchanger would be disposed facing upward toward the foot of the wearer and the hot side facing down toward the heel and sole of the shoe. However, there may be circumstances in which it is desired to warm the wearer's foot. In such cases, the heat exchanger may be reversed (e.g., by running direct current through it in the opposite direction so as to heat the foot, rather than cool it. Particularly, in cold climates, it may be more beneficial to heat the wearer's foot than cool it. Accordingly, the remote control unit or cellular telephone software application may include a feature that allows the user to choose to use the heat exchangers alternately to cool or heat the feet.

In an alternative embodiment, instead of reversing the polarity of the electrical signal in order to provide heating, a resistive element could be built in to the shoe for generating heat using power from the battery.

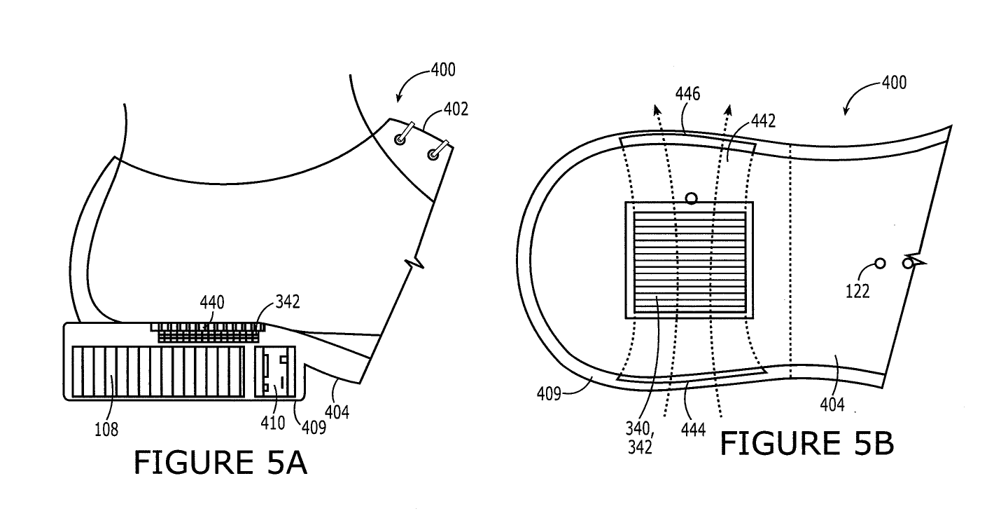

FIGS. 5A and 5B are partial side and bottom views of an alternative embodiment. This embodiment is largely similar to the embodiment of FIGS. 4A and 4B. However, this shoe 400 differs in that an ionic air mover 342 is attached directly to the bottom, hot side of a heat exchanger 440 and is adapted to move air in the XY plane of the air mover 342 to efficiently cool the heat exchanger and/or any heat sink (not shown) that might be attached to the heat exchanger 440. Accordingly, the air channel 442 and ports 444, 446 are designed for air flow substantially in the plane of the sole 404. In this embodiment, while some air flow into and through the upper 402 may occur if the area of the sole above or near the air mover 440 is air permeable, the focus of the air mover 342 is to cool the heat exchanger 440 by flowing air across its hot side.

The sensors 122 may be used to monitor the wearer's foot for health and other conditions entirely independently of the heat exchanger and/or air mover aspects of the footwear. For instance, sensors 122 may be temperature and/or moisture sensors and may be disposed at multiple points along the sole of the shoe to detect such conditions along a significant portion of the foot. The onboard electronics 110 may be designed to receive and interpret the data received from the sensors 122 and issue warnings through the wireless transceiver 111 to the remote control unit 137 or cell phone 139, which, in turn, will alert the wearer to certain conditions. Any such alerts need to be limited to the wearer. In embodiment utilizing a cellular telephone as a control unit, for instance, the software application on the telephone may be adapted to send a text message or make a call to another person if certain conditions are detected. For instance, in one embodiment, the sensors 122 may be used to detect and alert the wearer to situations in which a temperature differential exceeding some minimum temperature threshold, e.g., 4 degrees, exists between points on a single foot or between common points on each foot. Particularly, such hot spots may be pre-indicators of foot ulcers. Such alerts may be extremely useful to diabetic wearers with sensory neuropathy who may not be able to detect such hot spots on their own. There may be different degrees of indication of such conditions, such as a warning, an alert, and an alarm, so that the user can have some sense of the urgency of the situation.

Measurement may be taken via a grid or discrete points of thermocouples, RTDs (Resistance Temperature Detectors) solid state, or contact thermography.

In certain embodiments, the electronics 110 may collect sensor data over a period of hours, days, weeks, etc. and calculate and generate useful charts and other information about the sensor readings. In one embodiment, the on-board circuitry 110 collects and stores the data and then transmits it via the wireless transceiver 111 to the remote control unit 137, cell phone 139, or even to a computer that actually processes the raw sensor data into useful reports.

The sensors may further include pressure sensors and/or load-cell sensors that can be used to measure weight, monitor gait, or control cushioning adjustment.

In one embodiment, the shoe may contain one or more pressure sensors to detect whether a foot is in the shoe or not or when a person is standing or sitting versus hanging the shoe in the air (such as when one crosses his or her legs or is lying down) and adjust operation depending on such conditions. For instance, it may be desirable to turn off any cooling when the shoe is unworn or is being worn, but is suspended in the air. This could help avoid condensation problems when the foot and shoe are hanging loosely in the air, in which case there may not be good contact of the bottom of the foot with the sole of the shoe, thereby increasing the potential for condensation to form on the surfaces between the foot and the heat exchanger is the temperature differential therebetween is too great.

The battery 108 may be rechargeable. A port for charging the battery may be provided on the shoe and/or the battery may be removable from the shoe for charging. In a preferred embodiment, inductive charging technology may be used for charging the battery 108. For instance, in one embodiment, an inductive charging coil 120 (FIGS. 1B and 3) may be disposed in the sole of the shoe so that the shoes may be charged merely by placing them on an inductive charging mat 210 (FIG. 3). Thus, the wearer may leave his or her shoes on the mat 120 overnight so that they become fully charged. In other situations, the user may place the mat 120 under the desk at work, or in the car, so that his shoes are on the mat and charging for a substantial portion of the day even while he or she is actually wearing the shoes.

The mat 120 also may be formed of or at least include material having a high thermal conductivity so that, when the wearer is sitting or standing on the mat 120, the heat exchange efficiency of the thermoelectric heat exchanger(s) 340 is even further increased by the contact of the soles and/or heels of the shoes with the thermally conductive mat. The mat 120 further may be adapted to actively charge only when it detects one or more shoes on it. Further, the mat may be partitioned so that only parts of it are activated for charging as needed. In yet other embodiments, the mat may be cushioned for long term standing comfort and/or have an ergonomic raised shape for foot support/positioning when a user is sitting with his feet on the mat. The mat may be equipped with electronics and user interface, switches, buttons, and/or displays for charge and discharge control, especially for lithium ion batteries for safety purposes.

The battery 108 may be a distributed battery, particularly if it is a gel battery, and may be distributed along the shoe sole. A gel battery also may serve double duty to provide additional cushioning in the sole of the shoe. In yet other embodiments, it may be worn separately, such as strapped to the leg with a wire running down the leg to the shoe. Suitable battery technologies that are light weight, long lasting, and robust include lithium batteries, magnesium ion batteries, lithium polymer batteries, and lithium gel batteries.

In some embodiments, a temperature differential between the foot and the air when the device is not actively cooling (or heating) could be used to recharge the battery.

Obviously, shoes will be provided in different sizes for different wearers. Presumably, the smaller the wearer, the smaller the shoe he or she will need. Fortunately, the size of the shoe will scale with the energy requirements. More particularly, the smaller the wearer, the less energy required to cool (or heat) his or her feet inasmuch as a smaller person generally will require less cooling capacity than a larger person. Accordingly, the battery, thermoelectric heat exchanger, and/or ionic air mover may be scaled commensurately with the size of the shoe.

The remote control unit or software application on the cell phone as well as the electronics in the shoe may further be adapted to provide additional information about the operation, safety, or status of the electrical components on the shoe. For instance, the electronics may be adapted to warn the user when the battery is getting low or when one of the pieces of equipment, e.g., sensors, ionic air mover, thermoelectric heat exchanger, are not operating properly.

Note that, the heat exchanger(s) and/or air mover(s) need not be only in an on state or an off state, but may be run at varying levels of power. Also, as already noted, the shoe may be designed with two or more heat exchangers and/or air movers and it may be desirable to turn only some on at any given instant depending on conditions. Hence, the on-board electronics 110 may be adapted to control the cooling and or ventilating equipment to be turned on and off individually and/or at varying power levels according to a predetermined algorithm. For instance, a control algorithm may be executed by the on board electronics 110 to automatically adjust cooling and air movement intensity based on temperature and/or humidity readings from the sensors.

All of the above also may be controlled by the wearer through the remote control unit 137 of cell phone 129 as previously described. In one embodiment, the cooling and ventilating electronics alternately may be set (1) in an automatic mode to operate according to some predetermined algorithm or (2) in a manual mode that allows the user to manually control operation.

In one preferred embodiment, the electronics 110 have a learning algorithm to learn the preferences of the wearer over time when the shoe is operated in manual mode and then apply those learned behaviors to adjust the automatic algorithm used when the shoe is in automatic mode.

In addition to the aforementioned control functions, the software application could allow advanced configuration, visualization, and diagnostics of any and all key and support functions of the footwear and may also serve as a portal to the internet for reward programs, monitoring, data collection, social media, and firmware updates.

In yet other embodiments, any and all of the aforementioned remote control or software application functionality may be provided instead through a USB dongle for a PC.

In yet further embodiments, the footwear may include the ability to communicate wirelessly with pad computers, desktop computers, and laptop computers through blue tooth, wifi, or other wireless protocols.

One potential issue with the footwear of the present invention is that the electronics in the shoe may be mistaken for explosives or other dangerous items when passing through security at airports or the like. In order to minimize or avoid any such problems, the electronics may further be adapted to communicate in an encrypted protocol via blue tooth with handheld airport security devices having a corresponding software application to verify that the shoe is legitimate and has not been tampered with. The electronics may verify if the battery (the component mostly likely to be of concern with respect to the potential concealment of explosives) has been disconnected at any time and may also periodically and randomly load test the battery to ensure the full battery capacity is in place. Furthermore, the battery may also be tied in a tamper-resistant way to security electronics. The security software application, for instance, may continually ping an area for authentification of all “smart-shoes” within range and may issue a notification indicating whether any smart shoes are detected in range, and if one or more have been tampered with. Such notification can be reconciled by visual inspection of the shoe to confirm that it is of a brand known to sell shoes with electronics in them and/or x-ray to confirm that the electronics in the shoe appear to be the electronics expected for such a shoe. Thus, in a preferred embodiment, the electronics can tolerate x-rays. Furthermore with respect to security, it may be advisable to design the battery so that it will retain some capacity for the aforementioned security communications even when it is “fully” discharged, much like the situation for laptop computers, which are normally only x-rayed, but sometimes require a power on test.

In connection with embodiments of the invention utilizing the air mover and ventilation, foot odor may be a concern because the ventilation may expel the odor into the surrounding environment. Such odor comes from bacteria growth in a moist environment plus the smell of dampness. In accordance with the invention, by continuously controlling temperature and ventilation, sweat production is decreased and the sweat that is produced is quickly expelled, such that moisture does not have a chance to accumulate, thereby reducing or eliminating the instances of foot odor in the first place. An antibacterial insole and available antibacterial deodorants may be of assistance for any remaining concerns.

In yet other embodiments, footwear may be adapted to provide electrical stimulation in real time to promote healing and tissue growth.

In yet other embodiments, footwear may contain electrically-driven massage functionality to relax the foot.

In yet other embodiments, footwear may contain loudspeakers fed from the Bluetooth receiver (connected to a mobile device) and powered by the battery to generate sonic energy to vibrate or massage the foot.

In yet other embodiments, footwear may contain a cellular transceiver operably connected via Bluetooth to a mobile phone. For those instances where a Bluetooth headset is not used, reduced levels of electromagnetic radiation to the head is achieved by moving the high-energy radio output to the footwear while still allowing the user to talk into the phone held directly to the head.

Additional advantages of the present invention include assisting patients with hyperhidrosis through cooling and ventilation. Cooling provides anti-inflammation help for healing.

Having thus described a few particular embodiments of the invention, various alterations, modifications, and improvements will readily occur to those skilled in the art. Such alterations, modifications, and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

1. A footwear product comprising:
a bottom comprising a heel and a sole;
an upper; and
an air mover disposed in the bottom, the air mover having no moving parts.

2. The footwear product of claim 1 wherein the air mover is adapted to move air in a predetermined direction.

3. The footwear product of claim 2 wherein the air mover comprises first and second electrodes, at least one of the electrodes adapted to create ions in air by coronal discharge, the first and second electrodes further adapted to be charged with opposing polarities so as to force the ions to move in a predetermined direction relative to the electrodes.

4. The footwear product of claim 2 wherein the air mover is an ionic air mover.

5. The footwear product of claim 2 wherein the sole comprises at least one portion that is air permeable and wherein the air mover is disposed adjacent the at least one air permeable portion and wherein the predetermined direction is adapted to move air through the permeable portion.

6. The footwear product of claim 5 wherein the air mover comprises a plurality of air movers.

7. The footwear product of claim 6 wherein the plurality of air movers comprises at least a first air mover adapted to force air through the permeable portion of the sole upwardly into the upper and a second air mover adapted to force air through the permeable portion of the sole downwardly out of the upper.

8. The footwear product of claim 7 wherein one of the first and second air movers is disposed adjacent the heel of a wearer of the footwear product when worn and the other of the first and second air movers is disposed adjacent the toe of the wearer of the footwear product when worn.

9. The footwear product of claim 2 wherein the predetermined direction is substantially parallel to the sole.

10. The footwear product of claim 2 wherein the predetermined direction is substantially perpendicular to the sole.

11. The footwear product of claim 1 further comprising a heel and a battery adapted to power the air mover, the battery disposed in the heel.

12. The footwear product of claim 1 further comprising a battery coupled to power the air mover.

13. The footwear product of claim 1 further comprising at least one air channel disposed in the bottom and wherein the air mover is disposed within the air channel and further wherein the air channel includes at least one port in a surface of the bottom through which air can pass between the air channel and the environment outside of the footwear product.

14. The footwear product of claim 1 further comprising a heat exchanger disposed in the bottom.

15. The footwear product of claim 14 wherein the heat exchanger has no moving parts.

16. The footwear product of claim 14 wherein the heat exchanger is a Peltier effect heat exchanger.

17. The footwear product of claim 16 further comprising at least one air channel in the bottom and wherein the heat exchanger and the air mover are disposed in the at least one air channel with the air mover adapted to force air over the heat exchanger.

18. The footwear product of claim 17 wherein the heat exchanger has a substantially planar form factor having a first major surface and a second, opposed major surface and the air mover has a substantially planar form factor having a first major surface and a second, opposed major surface and wherein one of the major surfaces of the air mover is attached to one of the major surfaces of the heat exchanger.

19. The footwear product of claim 17 wherein the heat exchanger has a substantially planar form factor having a first major surface and a second, opposed major surface and the air mover has a substantially planar form factor having a first major surface and a second, opposed major surface, and wherein the air mover is disposed substantially coplanar with the heat exchanger and is adapted to blow air across the heat exchanger in a direction substantially coplanar with the heat exchanger and air mover.

20. The footwear product of claim 1 further comprising at least one sensor disposed in the bottom for sensing an environmental characteristic of the shoe.

21. The footwear product of claim 1 further comprising circuitry for operating the air mover.

22. The footwear product of claim 21 further comprising:
a wireless transceiver disposed in the shoe for communicating with a remote wireless communication device, the wireless transceiver adapted to permit control of the air mover and circuitry by operation of the wireless communication device.

23. The footwear product of claim 22 further comprising at least one sensor disposed in the bottom for sensing an environmental characteristic of the shoe and wherein the wireless transceiver is further adapted to transmit conditions sensed by the at least one sensor to the wireless communication device.

24. The footwear product of claim 20 further comprising an inductive charging coil disposed in the bottom, the inductive charging coil coupled to the battery so as to charge the battery when the inductive charging coil is inductively charged by an external source.
